(19) United States
(12) Patent Application Publication
(10) Pub. No.: US 2026/0127782 A1
(43) Pub. Date: May 7, 2026

(54) METHOD AND SYSTEM FOR INTELLIGENT IMAGE OR VIDEO GENERATION THROUGH LARGE LANGUAGE MODEL INTERACTION

(71) Applicant: Yin YU, Fuzhou (CN)

(72) Inventors: Yin YU, Fuzhou (CN); Ziyan YANG, Fuzhou (CN)

(21) Appl. No.: 19/424,240

(22) Filed: Dec. 18, 2025

Related U.S. Application Data
(63) Continuation of application No. PCT/CN2024/106325, filed on Jul. 19, 2024.

(30) Foreign Application Priority Data
Mar. 1, 2024 (CN) 202410233999.8

(51) Int. Cl. G06T 11/00; G06F 40/177; G06F 40/186; G06F 40/40; G06T 13/00

(52) U.S. Cl. CPC G06T 11/00; G06F 40/177; G06F 40/186; G06F 40/40; G06T 13/00; G06T 2200/24

(57) ABSTRACT

A method for intelligent image or video generation through large language model (LLM) interaction is provided. An original prompt request is received from a user, descriptive information is extracted from the original prompt request and populated into an internal storyboard template of a system, or the original prompt request and an external storyboard template are directly imported, and the external storyboard template is mapped to the internal storyboard template. The content within the storyboard template is serialized and textualized to obtain at least one prompt request segment each corresponding to one image or storyboard video. The at least one prompt request segment is submitted to the LLM one by one or in batch. An image or video content is generated and returned by the LLM. A system for intelligent image or video generation through LLM interaction is also provided.

### CROSS-REFERENCE TO RELATED APPLICATIONS

This application is a continuation of International Patent Application No. PCT/CN 2024/106325, filed on Jul. 19, 2024, which claims the benefit of priority from Chinese Patent Application No. 202410233999.8, filed on Mar. 1, 2024. The content of the aforementioned application, including any intervening amendments made thereto, is incorporated herein by reference in its entirety.

### TECHNICAL FIELD

This application relates to large language model (LLM) interaction, and more particularly to a method and system for intelligent image or video generation through LLM interaction.

### BACKGROUND

At present, multimodal large language models (LLMs) of artificial intelligence are developing rapidly. For example, models such as Stable Video and OpenAI Sora have already achieved text-to-image or text-to-video generation capabilities.

In the existing multimodal LLMs of artificial intelligence, the text-to-image or text-to-video generation process includes the following steps. A user submits a prompt request, provides a linguistic description of an image or scene to the LLM, and the LLM then returns the generated image or video.

The function of a prompt request primarily relies on a text/string template, which includes the scene theme, subject description, scene background, environment description, style definition and model parameters of the image or video.

As shown in FIG. 1, when an LLM performs text-to-image generation based on a prompt request, the user provides the prompt request shown on the left side of FIG. 1, and the LLM then generates the image shown on the right side of FIG. 1.

As shown in FIG. 2, when an LLM performs text-to-video generation based on a prompt request, the user provides the corresponding prompt request, and the LLM then generates the video shown in FIG. 3.

However, the existing multimodal LLMs of artificial intelligence exhibit the following deficiencies when performing text-to-image or text-to-video generation.
1. The interaction mode of the generation page is limited, typically supporting only single-item, item-by-item input interactions for text-to-image and text-to-video generation. All dimensional information of the scene is contained within the prompt. Newly released models such as Stable Video place camera state configurations in a secondary draft generation page for selection, which results in the lack of systematic management for prompt requests of each scene.
2. When a prompt request involves long-text descriptions, the user may lack descriptive dimensions, thereby affecting the quality of the image or video generated by the LLM.
3. When the LLM returns the generated content, the playback interaction modes are limited. Typically, only image and video browsers are provided, which merely support playback interactions such as playback, zooming, variable-speed playback, and skip playback.
4. Batch generation is not supported, leading to low efficiency.

### SUMMARY

An object of the disclosure is to provide a method and system for intelligent image or video generation through large language model (LLM) interaction, which can construct and provide users with a systematic storyboard template to achieve systematic and structured editing and management, while supporting batch generation and offering diverse interaction modes to enhance user interaction experience.

In order to achieve the above object, the following technical solutions are adopted.

In a first aspect, this application provides a method for intelligent image or video generation through LLM interaction, comprising:
an image or video generation process;
wherein the image or video generation process comprises:
(S11) receiving an original prompt request from a user, extracting descriptive information from the original prompt request, and populating the descriptive information into an internal storyboard template of a system; or
directly importing the original prompt request and an external storyboard template, and mapping the external storyboard template to the internal storyboard template;
(S12) serializing and textualizing a content within the storyboard template to obtain at least one prompt request segment, wherein each of the at least one prompt request segment corresponds to an image or a storyboard video; and
(S13) submitting the at least one prompt request segment one by one or in batch to an LLM to obtain a generated image or a generated video content, and returning, by the LLM, the generated image or the generated video content.

In a second aspect, this application provides a system for intelligent image or video generation through LLM interaction, comprising:
a template management module;
wherein the template management module is configured to perform steps of:
(S11) receiving an original prompt request from a user, extracting descriptive information from the original prompt request, and populating the descriptive information into an internal storyboard template of a system; or
directly importing the original prompt request and an external storyboard template, and mapping the external storyboard template to the internal storyboard template;
(S12) serializing and textualizing a content within the storyboard template to obtain at least one prompt request segment, wherein each of the at least one prompt request segment corresponds to an image or a storyboard video; and
(S13) submitting the at least one prompt request segment one by one or in batch to an LLM to obtain a generated image or a generated video content, and returning, by the LLM, the generated image or the generated video content.

Compared to the prior art, the present disclosure has the following beneficial effects.

The systematic storyboard template is constructed for users, which can automatically extract entity configurations from prompt requests, import and edit configurations to generate storyboard templates, or directly import storyboard templates from outside the system, thereby realizing systematic and structured editing and management of prompt requests and enhancing the interaction experience of the generation page. Meanwhile, individual generation or batch generation of segmented prompt requests is supported, which significantly improves the generation efficiency of images and videos. Based on the dynamic information editing function of the structured storyboard template, users can supplement descriptive dimensions at any time to ensure the quality of images or videos generated by the LLM. Furthermore, during playback of the generated result, corresponding parameters on the storyboard template can be modified or added in real time and submitted to the LLM according to the user's playback interaction input, enabling dynamic playback interaction and significantly improving the playback interaction experience.

The above description is only an overview of the technical solutions of the present disclosure. To enable a clearer understanding of the technical solutions of the present disclosure, implementations can be carried out in accordance with the content of the specification. Moreover, in order to understand the above objects, features and beneficial effects of the present disclosure more clearly, specific embodiments of the present disclosure will be described below.

### BRIEF DESCRIPTION OF THE DRAWINGS

The present disclosure will be further described below in conjunction with the embodiments and the accompanying drawings.

FIG. 1 is a schematic diagram of an interaction page of an existing large language model (LLM) when implementing a text-to-image generation function based on a prompt request in the prior art;

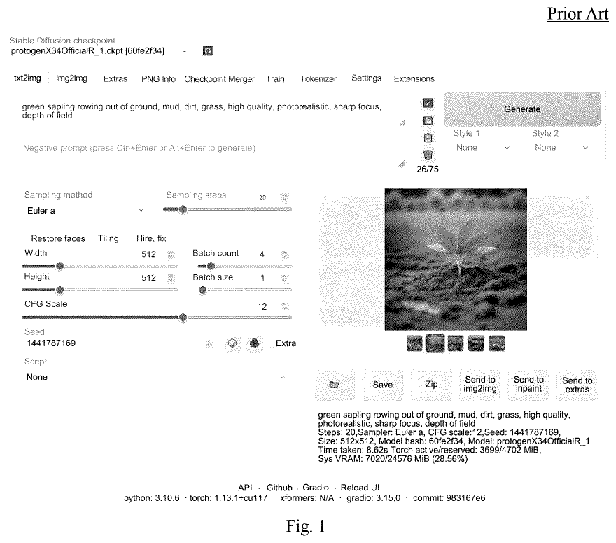

FIG. 2 a schematic diagram of an interaction page of the existing LLM when implementing a text-to-video generation function based on a prompt request in the prior art;

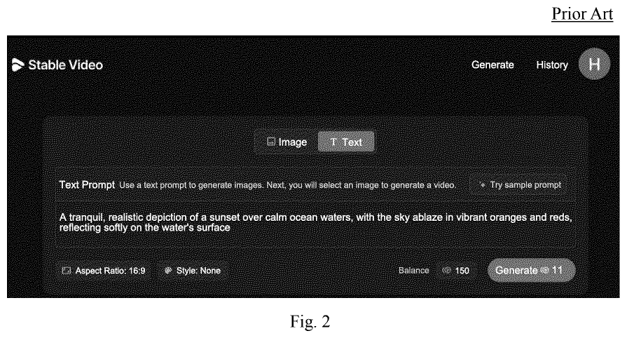

FIG. 3 is a schematic diagram of one frame of a video generated by the existing LLM based on a prompt request in the prior art;

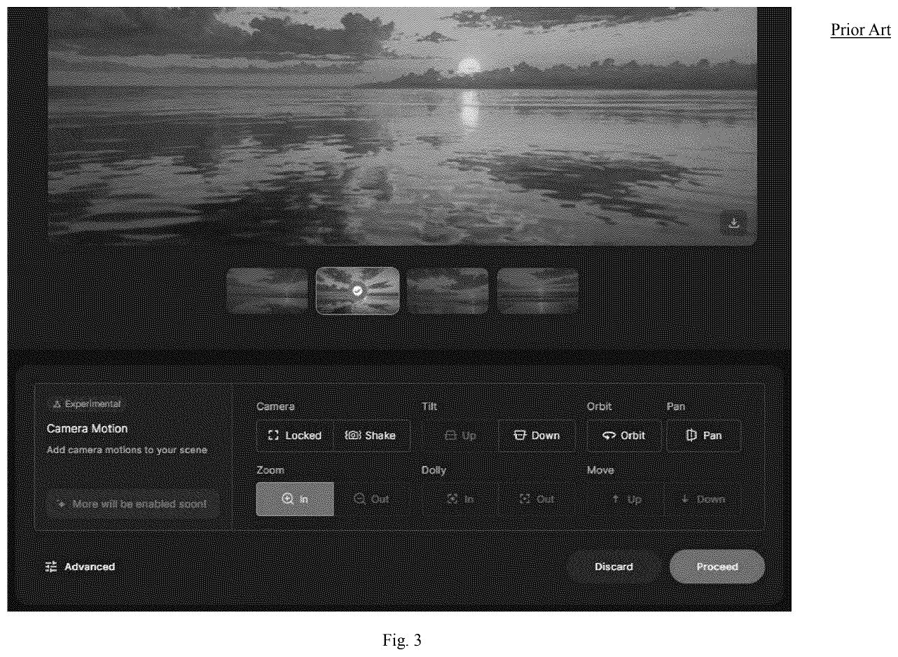

FIG. 4 is a flow chart of a method for intelligent image or video generation through LLM interaction in Embodiment 1 of the present disclosure;

FIG. 5 is a structural diagram of an internal storyboard template of a system in accordance with an embodiment of the present disclosure;

FIG. 6 is a structural diagram of an external storyboard template in accordance with an embodiment of the present disclosure;

FIG. 7 is a flow chart of a method for intelligent image or video generation through LLM interaction in Embodiment 2 of the present disclosure;

FIG. 8 is a block diagram of a system for intelligent image or video generation through LLM interaction in Embodiment 3 of the present disclosure; and

FIG. 9 is a flow chart of a dynamic playback interaction process in accordance with an embodiment of the present disclosure.

### DETAILED DESCRIPTION OF EMBODIMENTS

The embodiments of the present application provide a method and system for intelligent image or video generation through large language model (LLM) interaction, which constructs a systematic storyboard template for users, thereby achieving systematic and structured editing and management, while supporting batch generation, with diverse interaction methods to enhance the user interaction experience.

The technical solution in the embodiments of the present application has an overall approach as follows. A systematic storyboard template is constructed for users. An entity configuration of a prompt request is automatically extracted. Configurations are imported and edited to generate a storyboard template, or storyboard templates are directly imported from outside the system, thereby achieving systematic and structured editing and management of the prompt request and enhancing the interaction experience of the generation page. Additionally, the present application can support individual generation or batch generation of prompt request segments, thus significantly improving the image and video generation efficiency. Based on the dynamic editing function of information in the structured storyboard template, users can supplement description dimensions at any time to ensure the generation quality of images or videos by the LLM. During the playback of generation results, in response to the user playback interaction input, corresponding parameters on the storyboard template can be modified or added in real time and submitted to the LLM, thereby achieving dynamic playback interaction and significantly enhancing the playback interaction experience.

### Embodiment 1

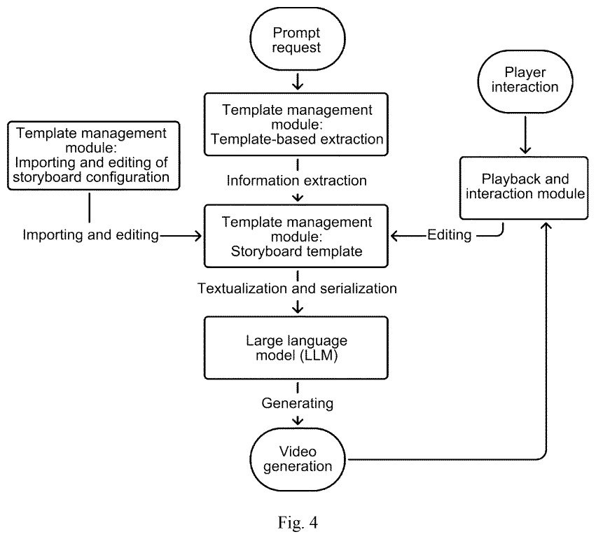

As shown in FIG. 4, this embodiment provides a method for intelligent image or video generation through LLM interaction, including an image or video generation process. The image or video generation process includes the following steps.

Step (S11) An original prompt request is received from a user, descriptive information is extracted from the original prompt request and populated into an internal storyboard template of a system; or the original prompt request and an external storyboard template are directly imported, and the external storyboard template is mapped to the internal storyboard template. The external storyboard template is a text file, a table file, or a Markdown configuration file in a JSON or YAML format.

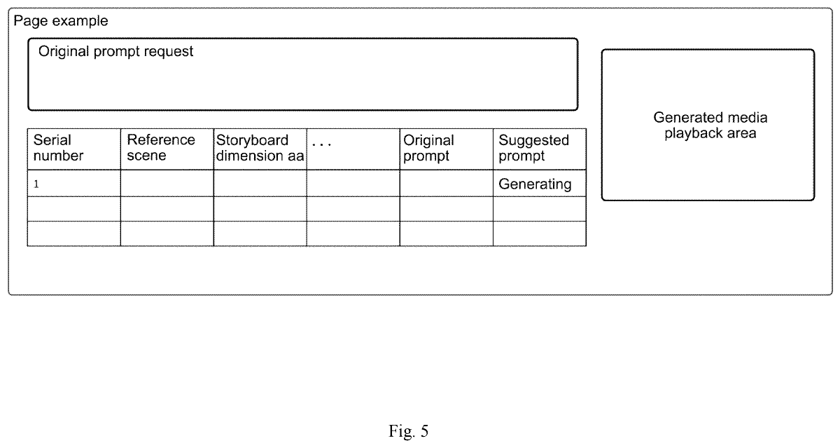

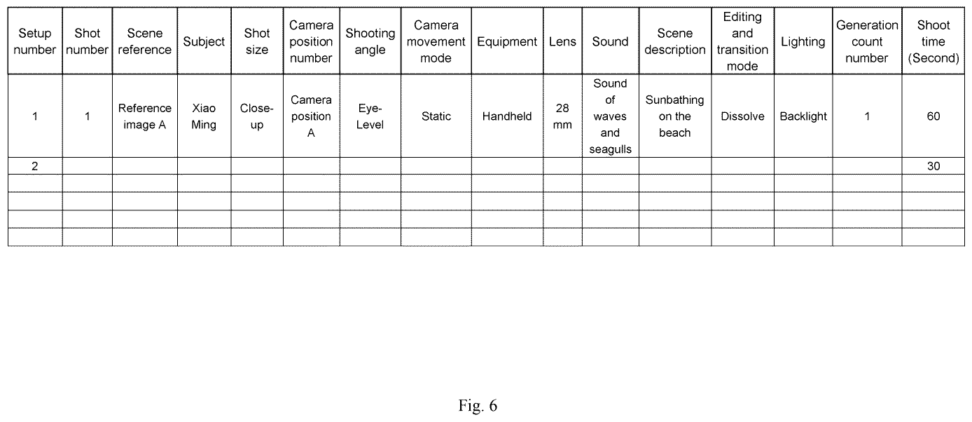

As shown in FIGS. 5 and 6, the storyboard template is displayed in a table form on the generation interaction page, and is maintained in a re-editable state.

The content within the storyboard template includes setup number, shot number, scene reference, subject, shot size, camera position number, shooting angle, camera movement mode, equipment, lens length, sound, scene description, editing and transition mode, lighting, generation count number and shooting time. In this way, tools for creative planning, scene design, shooting production, and post-production editing related to scene understanding and communication are covered, so that visual planning, production, or director requirements are more accurately transmitted, resulting in an improved communication and production efficiency.

Step (S12) The content within the storyboard template is serialized and textualized to obtain at least one prompt request segment, where each prompt request segment corresponds to one image or storyboard video.

The prompt request segment is capable of being correspondingly populated in the storyboard template.

Step (S13) The at least one prompt request segment is submitted to the LLM one by one or in batch. Specifically, a single-execution trigger button is set for each prompt request segment, and a batch-execution trigger button is set for the entire storyboard template. After the user triggering is executed, an image or video content is generated and returned by the LLM.

As shown in FIG. 4, conventional video playback includes normal playback, zoom playback, variable-speed playback, skip playback, and other standard playback methods. The generation method of this embodiment may further include a dynamic playback interaction process.

Step (S21) During playback of the generated video result, a playback interaction input by the user is received in real time.

Step (S22) Based on a preset playback interaction rule or a preset playback interaction use case, the playback interaction and a timestamp, a corresponding video reference frame and a corresponding descriptive text are located, corresponding parameters on the storyboard template are modified or added in real time to obtain modified or added parameters, and the modified or added parameters are submitted to the LLM.

Step (S23) A regenerated image or video content is regenerated and returned by the LLM in real time.

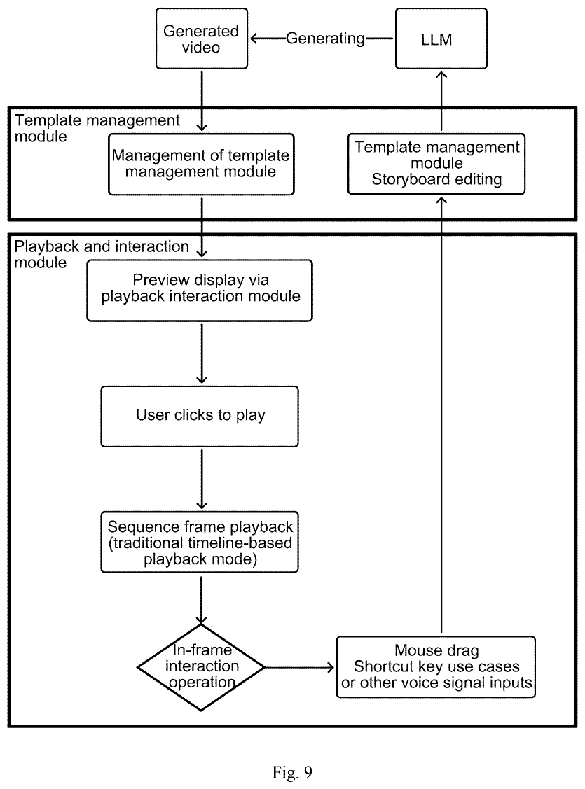

As shown in FIG. 9, the dynamic playback interaction process allows the user to interact with sequence frames in the video. Through playback interaction inputs, corresponding video reference frames and descriptive text are indexed based on the timestamp, corresponding parameters on the storyboard template are modified or added in real time to achieve scene content interaction, such as video footage movements simulated via mouse interactions or supplementing and generating visual effects via keyboard shortcuts, so that video playback interaction is extended from static sequence frame playback interaction to immersive interaction within the generated content.

The playback interaction input by the user includes, but is not limited to, keyboard input, mouse input, audio input, motion input and video input. The preset playback interaction rule or the preset playback interaction use case is provided by the system or is user-defined.

The playback interaction rule is exemplified by the mouse operation as follows.

During video playback, when the user performs left-clicking and dragging left/right, the camera movement parameter is modified to push left/push right.

During video playback, when the user performs right-clicking and dragging left/right, the camera movement parameter is modified to pan left/pan right, and when the user performs right-clicking and dragging forward/backward, the camera movement parameter is modified to tilt up/down.

During video playback, when the mouse is scrolled, a zoom-in operation is performed, and when the wheel of the mouse is clicked forward/backward, forward/rewind is performed.

The playback interaction use case may include effects such as rain or snow falling across the screen.

### Embodiment 2

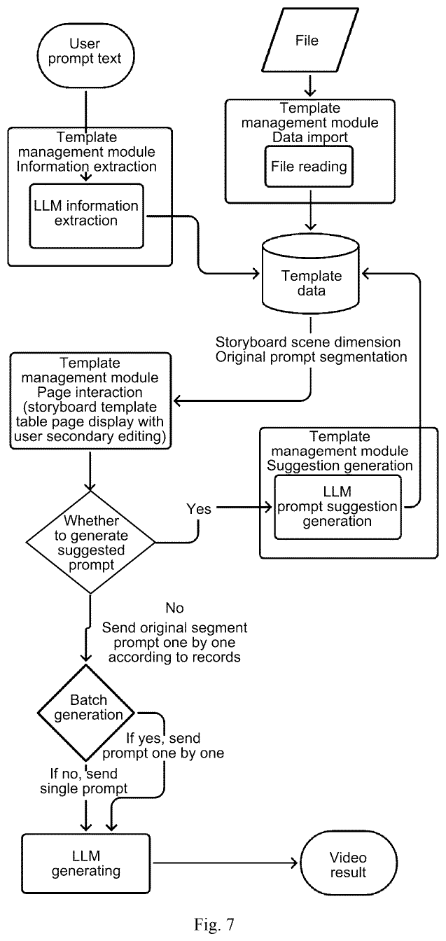

As shown in FIG. 7, this embodiment provides a method for intelligent image or video generation through LLM interaction, which further provides a function for generating suggested prompts on the basis of Embodiment 1. Specifically, after step of serializing and textualizing the content within the storyboard template to obtain the at least one prompt request segment of step (S12), each prompt request segment is also capable of generating a suggested prompt in response to a user trigger, and the suggested prompt is submitted to the LLM in place of the prompt request segment. This can address the limitations of the user's prompt request segments, leading to a higher quality of images or videos generated by the LLM.

The user trigger may be set at positions in the storyboard template on the generation interaction page corresponding to each prompt request segment.

Embodiment 2 further provides an option for the prompt request segments to be submitted to the LLM one by one or in batch. Specifically, a single-execution trigger button is set for each prompt request segment, and a batch-execution trigger button is set for the entire storyboard template. After the user triggering is executed, an image or video content is generated and returned by the LLM.

### Embodiment 3

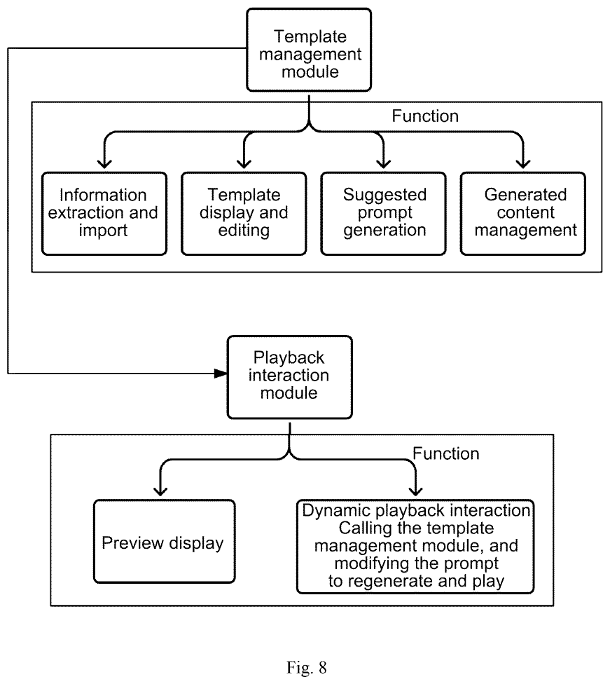

As shown in FIG. 8, this embodiment provides a system for intelligent image or video generation through LLM interaction, which is a device corresponding to the method in Embodiment 1. The system includes a template management module, and may further include a dynamic playback interaction module.

As shown in FIG. 4, the template management module is configured to perform the following steps.

Step (S11) An original prompt request is received from a user, descriptive information is extracted from the original prompt request and populated into an internal storyboard template of a system; or the original prompt request and an external storyboard template are directly imported, and the external storyboard template is mapped to the internal storyboard template. The external storyboard template is a text file, a table file, or a Markdown configuration file in a JSON or YAML format.

Step (S12) The content within the storyboard template is serialized and textualized to obtain at least one prompt request segment, where each prompt request segment corresponds to one image or storyboard video.

Step (S13) The at least one prompt request segment is submitted to the LLM one by one or in batch. An image or video content is generated by the LLM.

This embodiment further provides an option for the prompt request segments to be submitted to the LLM one by one or in batch. Specifically, a single-execution trigger button is set for each prompt request segment, and a batch-execution trigger button is set for the entire storyboard template. After the user triggering is executed, an image or video content is generated and returned by the LLM.

As shown in FIGS. 5 and 6, the storyboard template is displayed in a table form on the generation interaction page, and is maintained in a re-editable state.

The content within the storyboard template includes setup number, shot number, scene reference, subject, shot size, camera position number, shooting angle, camera movement mode, equipment, lens length, sound, scene description, editing and transition mode, lighting, generation count number and shooting time.

The template management module is further configured to perform the following steps.

The at least one prompt request segment is correspondingly populated within the storyboard template. A suggested prompt is generated by each of the at least one prompt request segment in response to a user trigger. The at least one prompt request segment is replaced with the suggested prompt to be submit to the LLM.

As shown in FIG. 4, the dynamic playback interaction module is configured to perform the following steps.

Step (S21) During playback of the generated video result, a playback interaction input by the user is received in real time.

Step (S22) Based on a preset playback interaction rule or a preset playback interaction use case, the playback interaction and a timestamp, a corresponding video reference frame and a corresponding descriptive text are located, corresponding parameters on the storyboard template are modified or added in real time to obtain modified or added parameters, and the modified or added parameters are submitted to the LLM.

Step (S23) A regenerated image or video content is regenerated and returned by the LLM in real time.

The preset playback interaction rule or the preset playback interaction use case is provided by the system or is user-defined.

As shown in FIG. 9, the dynamic playback interaction process allows the user to interact with sequence frames in the video. Through playback interaction inputs, corresponding video reference frames and descriptive text are indexed based on the timestamp, corresponding parameters on the storyboard template are modified or added in real time to achieve visual content interaction, such as video footage movements simulated via mouse interactions or supplementing and generating visual effects via keyboard shortcuts, so that video playback interaction is extended from static sequence frame playback interaction to immersive interaction within the generated content.

The playback interaction input by the user includes, but is not limited to, keyboard input, mouse input, audio input, motion input and video input. The preset playback interaction rule or the preset playback interaction use case is provided by the system or is user-defined.

The playback interaction rule is exemplified by the mouse operation as follows.

During video playback, when the user performs left-clicking and dragging left/right, the camera movement parameter is modified to push left/push right.

During video playback, when the user performs right-clicking and dragging left/right, the camera movement parameter is modified to pan left/pan right, and when the user performs right-clicking and dragging forward/backward, the camera movement parameter is modified to tilt up/down.

During video playback, when the mouse is scrolled, a zoom-in operation is performed, and when the wheel of the mouse is clicked forward/backward, forward/rewind is performed.

The playback interaction use case may include effects such as rain or snow falling across the screen.

In summary, the embodiments of the present application have at least the following technical effects and advantages. A systematic storyboard template is constructed for users. An entity configuration of a prompt request is automatically extracted. Configurations are imported and edited to generate a storyboard template, or storyboard templates are directly imported from outside the system, thereby achieving systematic and structured editing and management of the prompt request and enhancing the interaction experience of the generation page. Additionally, the present application can support individual generation or batch generation of prompt request segments, thus significantly improving image and video generation efficiency. Based on the dynamic editing function of information in the structured storyboard template, users can supplement description dimensions at any time to ensure the generation quality of images or videos by the LLM. During the playback of generation results, in response to the user playback interaction input, corresponding parameters on the storyboard template can be modified or added in real time and submitted to the LLM, thereby achieving dynamic playback interaction and significantly enhancing the playback interaction experience.

The embodiments of the present disclosure have been described above. However, those of ordinary skill in the art should understand that the embodiments described above are merely illustrative of the present disclosure, and are not intended to limit the patent scope of the present in disclosure. Equivalent modifications and variations made by those skilled in the art without departing from the spirit and scope of the present disclosure shall fall within the scope of the present disclosure defined by the appended claims.

What is claimed is:

1. A method for intelligent image or video generation through large language model (LLM) interaction, comprising:
an image or video generation process;
wherein the image or video generation process comprises:
(S11) receiving an original prompt request from a user, extracting descriptive information from the original prompt request, and populating the descriptive information into an internal storyboard template of a system; or
directly importing the original prompt request and an external storyboard template, and mapping the external storyboard template to the internal storyboard template;
(S12) serializing and textualizing a content within the storyboard template to obtain at least one prompt request segment, wherein each of the at least one prompt request segment corresponds to an image or a storyboard video; and
(S13) submitting the at least one prompt request segment one by one or in batch to an LLM to obtain a generated image or a generated video content, and returning, by the LLM, the generated image or the generated video content.

2. The method of claim 1, wherein the storyboard template is configured to be displayed in a table form on a generation interaction page, and is in a re-editable state;
the content within the storyboard template comprises setup number, shot number, scene reference, subject, shot size, camera position number, shooting angle, camera movement mode, equipment, lens length, sound, scene description, editing and transition mode, lighting, generation count number and shooting time; and
the external storyboard template is a text file, a table file, or a Markdown configuration file in a JSON format or a YAML format.

3. The method of claim 1, further comprising:
correspondingly populating the at least one prompt request segment within the storyboard template; generating, by each of the at least one prompt request segment, a suggested prompt in response to a user trigger; and replacing the at least one prompt request segment with the suggested prompt, and submitting the suggested prompt to the LLM.

4. The method of claim 1, further comprising:
a dynamic playback interaction process;
wherein the dynamic playback interaction process comprises:
(S21) during playback of the generated video content, receiving a playback interaction input by the user in real time;
(S22) based on a preset playback interaction rule or a preset playback interaction use case, the playback interaction and a timestamp, locating a corresponding video reference frame and a corresponding descriptive text, modifying or adding corresponding parameters on the storyboard template in real time to obtain modified or added parameters, and submitting the modified or added parameters to the LLM; and
(S23) regenerating and returning, by the LLM, a regenerated image or a regenerated video content in real time.

5. The method of claim 4, wherein the preset playback interaction rule or the preset playback interaction use case is provided by the system or is user-defined.

6. A system for intelligent image or video generation through LLM interaction, comprising:
a template management module;
wherein the template management module is configured to perform steps of:
(S11) receiving an original prompt request from a user, extracting descriptive information from the original prompt request, and populating the descriptive information into an internal storyboard template of a system; or
directly importing the original prompt request and an external storyboard template, and mapping the external storyboard template to the internal storyboard template;
(S12) serializing and textualizing a content within the storyboard template to obtain at least one prompt request segment, wherein each of the at least one prompt request segment corresponds to an image or a storyboard video; and
(S13) submitting the at least one prompt request segment one by one or in batch to an LLM to obtain a generated image or a generated video content.

7. The system of claim 6, wherein the storyboard template is configured to be displayed in a table form on a generation interaction page, and is in a re-editable state;
the content within the storyboard template comprises setup number, shot number, scene reference, subject, shot size, camera position number, shooting angle, camera movement mode, equipment, lens length, sound, scene description, editing and transition mode, lighting, generation count number and shooting time; and
the external storyboard template is a text file, a table file, or a Markdown configuration file in a JSON format or a YAML format.

8. The system of claim 6, wherein the template management module is further configured to perform steps of:
correspondingly populating the at least one prompt request segment within the storyboard template; generating, by each of the at least one prompt request segment, a suggested prompt in response to a user trigger; and replacing the at least one prompt request segment with the suggested prompt, and submitting the suggested prompt to the LLM.

9. The system of claim 6, further comprising:
a dynamic playback interaction module;
wherein the dynamic playback interaction module is configured to perform steps of:
(S21) during playback of the generated video content, receiving a playback interaction input by the user in real time;
(S22) based on a preset playback interaction rule or a preset playback interaction use case, the playback interaction and a timestamp, locating a corresponding video reference frame and a corresponding descriptive text, modifying or adding corresponding parameters on the storyboard template in real time to obtain modified or added parameters, and submitting the modified or added parameters to the LLM; and
(S23) regenerating and returning, by the LLM, a regenerated image or a regenerated video content in real time.

10. The system of claim 9, wherein the preset playback interaction rule or the preset playback interaction use case is provided by the system or is user-defined.
